(19) United States
(12) Patent Application Publication
(10) Pub. No.: US 2014/0277975 A1
(43) Pub. Date: Sep. 18, 2014

(54) METHOD AND SYSTEM FOR ENGINE CONTROL

(71) Applicant: FORD GLOBAL TECHNOLOGIES, LLC, Dearborn, MI (US)

(72) Inventors: Ed Badillo, Flat Rock, MI (US); Dev Saberwal, Canton, MI (US); Samuel Guido, Dearborn, MI (US); Ross Dykstra Pursifull, Dearborn, MI (US)

(73) Assignee: FORD GLOBAL TECHNOLOGIES, LLC, Dearborn, MI (US)

(21) Appl. No.: 13/841,611

(22) Filed: Mar. 15, 2013

(51) Int. Cl. B60W 10/11; B60W 10/06

(52) U.S. Cl. CPC B60W 10/11; B60W 10/06
USPC 701/54; 477/115

(57) ABSTRACT

Methods and systems are provided for adjusting a transmission shift schedule in engine systems configured to operate with multiple fuels. During low engine speed and high engine load conditions, when an air charge temperature is elevated, engine operation is shifted from gasoline usage to CNG usage. The torque advantage of CNG usage is leveraged to advance a transmission upshift schedule and delay a downshift schedule to improve vehicle responsiveness when operating with CNG only.

### FIELD

The present application relates to adjusting engine operation in a bi-fuel vehicle using compressed natural gas.

### BACKGROUND/SUMMARY

Alternate fuels have been developed to mitigate the rising prices of conventional fuels and for reducing exhaust emissions. For example, natural gas has been recognized as an attractive alternative fuel. For automotive applications, natural gas may be compressed and stored as a gas in cylinders at high pressure. Various engine systems may be used with CNG fuels, utilizing various engine technologies and injection technologies that are adapted to the specific physical and chemical properties of CNG fuels. For example, mono-fuel engine systems may be configured to operate only with CNG while multi-fuel systems may be configured to operate with CNG and one or more other fuels, such as gasoline or gasoline blend liquid fuels. Engine control systems may operate such multi-fuels systems in various operating modes based on engine operating conditions.

One example multi-fuel system is described by Surnilla et al. in U.S. Pat. No. 7,703,435. Therein, an engine is configured to operate on CNG, gasoline, or a mixture of both. Fuel is selected for operating the engine during particular operating conditions based on the amount of fuel available in each fuel storage tank as well as based on the type and attributes of the available fuel. For example, vehicle mileage can be extended by selecting a particular fuel during high driver demand. As another example, engine emissions can be improved by reserving a particular fuel for engine starting conditions.

However the inventors herein have recognized that the approach of '435 may not leverage all the attributes of the available fuels. For example, the approach does not take into consideration the torque advantage of certain fuels and fuel combinations at particular speed-load conditions. For example, while CNG fuel generates less torque than gasoline at most engine speed-load conditions, at selected speed-load conditions, such as at low engine speed and high load, while the engine is hot (e.g., engine coolant temperature and engine air charge temperature is high), the peak torque output of CNG may be higher than gasoline. Likewise, there may be selected conditions, where co-fueling with CNG and gasoline provides a torque advantage over either fuel alone. During selected engine operating conditions, the area where CNG provides a torque advantage may also be an area where gasoline operation is knock limited. The inventors herein have recognized that during the selected conditions where CNG provides a torque advantage, a transmission shift schedule of the engine can be adjusted to improve vehicle performance. For example, vehicle performance can be improved by a method comprising selectively adjusting a transmission shift schedule in response to shifting engine operation with a first, liquid fuel to operating with only a second, gaseous fuel. By selectively adjusting the transmission shift schedule during conditions when injection of the gaseous fuel produces higher peak torque than injection of the liquid fuel, the responsiveness and fuel economy of a vehicle running on a gaseous fuel, such as CNG, is improved.

As an example, an engine may be configured to operate on a first, gaseous fuel, such as CNG, and a second, liquid fuel, such as gasoline. For example, the engine may receive CNG via port injection and gasoline via direct injection. Based on engine operating conditions, an engine cylinder may be injected with a variable ratio of the first fuel and the second fuel, while maintaining cylinder combustion at stoichiometry. This may include operating the engine with only gasoline injection during some conditions, only CNG injection during other conditions, and co-fueling with both fuels during still other conditions. During high load and low engine speed conditions (e.g., in the range of 1000-1500 rpm), when coolant and air charge temperatures are elevated, the engine may become knock limited if operating with any amount of gasoline. Knock limited fuels require spark retard which in turn reduces torque and increases brake specific fuel consumption. In one example, the peak torque output with only CNG injection may be 120% the peak torque output with only gasoline injection under the same conditions. In other words, during such conditions, shifting to engine operation with only CNG may provide a torque advantage. This higher torque output also enables the transmission shift schedule to be adjusted towards an earlier upshift and a later downshift. By advancing the upshift schedule and delaying the downshift schedule, the vehicle responsiveness when operating with CNG is improved, making the engine feel “torque-ier” when operating with CNG. In addition, the downshifting during CNG operation helps improve fuel economy by reducing the need to run rich or operate with spark retard. In particular, the octane of CNG reduces the spark retard required by high load operation with hot intake air and hot coolant temperature. Thus the engine produces more torque at a lower engine speed than gasoline. This provides the customer driveablity enhancement of high torque at low engine speed and lower fuel consumption. As a result, the need for spark retard (to address knock) is reduced, decreasing torque losses and power losses associated with the spark retard. As such, this improves fuel economy. Without the upshifting associated with gasoline operation, the brake specific fuel consumption (BSFC) is improved by lower engine speed and lower pumping losses.

In this way, a shift to CNG operation may be advantageously used in a multi-fuel system to take advantage of the high torque output of the fuel at selected engine operating conditions. The torque advantage of CNG usage at those conditions can also be leveraged to enable an earlier transmission upshift and a later transmission downshift. By adjusting the transmission shift schedule in response to a shift from gasoline usage to only CNG usage, vehicle responsiveness during CNG usage can be improved and made comparable to vehicle responsiveness during gasoline usage. Overall, engine performance and operator drive feel is improved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of a multi-fuel engine system configured to operate with a liquid fuel and a gaseous fuel.

FIG. 2 shows an example flowchart for adjusting a transmission shift schedule in a multi-fuel engine system responsive to fuel injection changes.

FIG. 3 shows an example map depicting the torque advantage provided by CNG usage, over gasoline usage, at low engine speeds.

FIG. 4 shows example maps comparing the torque outputs of fueling an engine with CNG and/or gasoline at different engine speed-load regions.

FIG. 5 shows an example map depicting early transmission upshifts that are enabled with the usage of CNG.

FIG. 6 shows an example transmission shift adjustment according to the present disclosure.

### DETAILED DESCRIPTION

Methods and systems are provided for adjusting a transmission shift schedule in a multi-fuel engine system, such as the system of FIG. 1. A controller may be configured to shift to CNG only operation during selected operating conditions to provide a torque advantage over gasoline only operation (FIGS. 3-4). During those conditions, the controller may also adjust a transmission shift schedule to take advantage of the increased peak torque output upon CNG usage. For example, the controller may perform a control routine, such as the routine of FIG. 2, to advance an upshift schedule and delay a downshift schedule of the transmission (FIG. 5) when operating at conditions where CNG usage provides a torque advantage. An example adjustment is described herein with reference to FIG. 6. In this way, the torque response of a vehicle operating on CNG can be improved.

FIG. 1 depicts an example embodiment of a combustion chamber or cylinder of internal combustion engine 10. Engine 10 may be controlled at least partially by a control system including controller 12 and by input from a vehicle operator 130 via an input device 132. In this example, input device 132 includes an accelerator pedal and a pedal position sensor 134 for generating a proportional pedal position signal PP. Cylinder (i.e. combustion chamber) 14 of engine 10 may include combustion chamber walls 136 with piston 138 positioned therein. Piston 138 may be coupled to crankshaft 140 so that reciprocating motion of the piston is translated into rotational motion of the crankshaft. Crankshaft 140 may be coupled to at least one drive wheel of the passenger vehicle via a transmission system. Further, a starter motor may be coupled to crankshaft 140 via a flywheel to enable a starting operation of engine 10.

Engine 10 may be coupled to a transmission 30 having one or more transmission gears. An engine output torque may be transmitted to transmission 30 along a driveshaft via a torque converter. Transmission 30 may include a plurality of gears, or gear clutches 33, that may be engaged as needed to activate a plurality of fixed transmission gear ratios. Specifically, by adjusting the engagement of the plurality of gear clutches 33, the transmission may be shifted between a higher gear (that is, a gear with a lower gear ratio) and a lower gear (that is, a gear with a higher gear ratio). As such, the gear ratio difference enables a lower torque multiplication across the transmission when in the higher gear while enabling a higher torque multiplication across the transmission when in the lower gear. A controller may vary the transmission gear (e.g., upshift or downshift the transmission) to adjust an amount of torque conveyed across the transmission to vehicle wheels 36. For example, by upshifting the transmission from a lower transmission gear to a higher transmission gear (e.g., from a first gear to a second gear), an engine shaft output torque may be decreased. Likewise, by downshifting the transmission from a higher transmission gear to a lower transmission gear (e.g., from a second gear to a first gear), an engine shaft output torque may be increased. As elaborated herein, during selected conditions, the controller may vary a transmission shift schedule (including the upshift schedule and the downshift schedule) based on fuel usage to improve vehicle responsiveness.

Cylinder 14 can receive intake air via a series of intake air passages 142, 144, and 146. Intake air passage 146 can communicate with other cylinders of engine 10 in addition to cylinder 14. In some embodiments, one or more of the intake passages may include a boosting device such as a turbocharger or a supercharger. For example, FIG. 1 shows engine 10 configured with a turbocharger including a compressor 174 arranged between intake passages 142 and 144, and an exhaust turbine 176 arranged along exhaust passage 148. Compressor 174 may be at least partially powered by exhaust turbine 176 via a shaft 180 where the boosting device is configured as a turbocharger. However, in other examples, such as where engine 10 is provided with a supercharger, exhaust turbine 176 may be optionally omitted, where compressor 174 may be powered by mechanical input from a motor or the engine. A throttle 162 including a throttle plate 164 may be provided along an intake passage of the engine for varying the flow rate and/or pressure of intake air provided to the engine cylinders. For example, throttle 162 may be disposed downstream of compressor 174 as shown in FIG. 1, or may alternatively be provided upstream of compressor 174.

Exhaust passage 148 can receive exhaust gases from other cylinders of engine 10 in addition to cylinder 14. Exhaust gas sensor 128 is shown coupled to exhaust passage 148 upstream of emission control device 178. Sensor 128 may be any suitable sensor for providing an indication of exhaust gas air/fuel ratio such as a linear oxygen sensor or UEGO (universal or wide-range exhaust gas oxygen), a two-state oxygen sensor or EGO (as depicted), a HEGO (heated EGO), a NOx, HC, or CO sensor. Emission control device 178 may be a three way catalyst (TWC), NOx trap, various other emission control devices, or combinations thereof. Engine 10 may include an exhaust gas recirculation (EGR) system indicated generally at 194. EGR system 194 may include an EGR cooler 196 disposed along the EGR conduit 198. Further, the EGR system may include an EGR valve 197 disposed along EGR conduit 198 to regulate the amount of exhaust gas recirculated to the intake manifold 144.

Each cylinder of engine 10 may include one or more intake valves and one or more exhaust valves. For example, cylinder 14 is shown including at least one intake poppet valve 150 and at least one exhaust poppet valve 156 located at an upper region of cylinder 14. In some embodiments, each cylinder of engine 10, including cylinder 14, may include at least two intake poppet valves and at least two exhaust poppet valves located at an upper region of the cylinder.

Intake valve 150 may be controlled by controller 12 via actuator 152. Similarly, exhaust valve 156 may be controlled by controller 12 via actuator 154. During some conditions, controller 12 may vary the signals provided to actuators 152 and 154 to control the opening and closing timing and/or lift amount of the respective intake and exhaust valves. The position of intake valve 150 and exhaust valve 156 may be determined by respective valve position sensors (not shown). The valve actuators may include electric valve actuation or cam actuation, or a combination thereof. In the example of cam actuation, each cam actuation system may include one or more cams and may utilize one or more of cam profile switching (CPS), variable cam timing (VCT), variable valve timing (VVT) and/or variable valve lift (VVL) systems that may be operated by controller 12 to vary valve operation. For example, cylinder 14 may alternatively include an intake valve controlled via electric valve actuation and an exhaust valve controlled via cam actuation including CPS and/or VCT. In other embodiments, the intake and exhaust valves may be controlled by a common valve actuator or actuation system, or a variable valve timing actuator or actuation system.

In some embodiments, each cylinder of engine 10 may include a spark plug 192 for initiating combustion. Ignition system 190 can provide an ignition spark to combustion chamber 14 via spark plug 192 in response to a spark advance signal SA from controller 12, under select operating modes. However, in some embodiments, spark plug 192 may be omitted, such as where engine 10 may initiate combustion by auto-ignition or by injection of fuel as may be the case with some diesel engines.

In some embodiments, each cylinder of engine 10 may be configured with one or more fuel injectors for providing fuel thereto. As a non-limiting example, cylinder 14 is shown including two fuel injectors 166 and 170. Fuel injector 166 is shown coupled directly to cylinder 14 for injecting fuel directly therein in proportion to the pulse width of signal FPW-1 received from controller 12 via electronic driver 168. In this manner, fuel injector 166 provides what is known as direct injection (hereafter referred to as “DI”) of fuel into combustion cylinder 14. While FIG. 1 shows injector 166 as a side injector, it may also be located overhead of the piston, such as near the position of spark plug 192. Fuel may be delivered to fuel injector 166 from first fuel system 172, which may be a liquid (e.g., gasoline, ethanol, or combinations thereof) fuel system, including a fuel tank, fuel pumps, and a fuel rail. In one example as shown in FIG. 1, fuel system 172 may include a fuel tank 182 and a fuel sensor 184, for example a liquid level sensor, to detect the storage amount in the fuel tank 182. Alternatively, fuel may be delivered by a single stage fuel pump at lower pressure, in which case the timing of the direct fuel injection may be more limited during the compression stroke than if a high pressure fuel system is used.

Fuel injector 170 is shown arranged in intake passage 146, rather than in cylinder 14, in a configuration that provides what is known as port injection of fuel (hereafter referred to as “PFI”) into the intake port upstream of cylinder 14. Fuel injector 170 may inject fuel in proportion to the pulse width of signal FPW-2 received from controller 12 via electronic driver 171. Fuel may be delivered to fuel injector 170 by a second fuel system 173, which may be a high pressure fuel system, including a fuel tank, a fuel pump, and a fuel rail. In one example as shown in FIG. 1, the fuel system 173 may include a pressurized gas fuel tank 183, and a fuel pressure sensor 185 to detect the fuel pressure in the fuel tank 183. Note that a single driver 168 or 171 may be used for both fuel injection systems, or multiple drivers, for example driver 168 for fuel injector 166 and driver 171 for fuel injector 170, may be used, as depicted. The fuel system 173 may be a gaseous fuel system. For example, the gaseous fuels may include CNG, hydrogen, LPG, LNG, etc. or combinations thereof. It will be appreciated that gaseous fuels, as referred to herein, are fuels that are gaseous at atmospheric conditions but may be in liquid form while at high pressure (specifically, above saturation pressure) in the fuel system. In comparison, liquid fuels, as referred to herein, are fuels that are liquid at atmospheric conditions.

It will be appreciated that while the depicted embodiment is configured to deliver one fuel via direct injection and another fuel via port injection, in still further embodiments, the engine system may include multiple port injectors wherein each of the gaseous fuel and the liquid fuel is delivered to a cylinder via port injection. Likewise, in other embodiments, the engine system may include multiple direct injectors wherein each of the gaseous fuel and the liquid fuel is delivered to a cylinder via direct injection.

The delivery of the different fuels may be referred to as a fuel type, such that the fuel type may be varied by injection relatively more or less of the liquid fuel compared with the gaseous fuel, or vice versa.

Controller 12 is shown in FIG. 1 as a microcomputer, including microprocessor unit 106, input/output ports 108, an electronic storage medium for executable programs and calibration values shown as read only memory chip 110 in this particular example, random access memory 112, keep alive memory 114, and a data bus. Controller 12 may receive various signals from sensors coupled to engine 10, in addition to those signals previously discussed, including measurement of inducted mass air flow (MAF) from mass air flow sensor 124; engine coolant temperature (ECT) from temperature sensor 116 coupled to cooling sleeve 118; a profile ignition pickup signal (PIP) from Hall effect sensor 120 (or other type) coupled to crankshaft 140; throttle position (TP) from a throttle position sensor; and absolute manifold pressure signal, MAP, from sensor 122. Engine speed signal, RPM, may be generated by controller 12 from signal PIP. Manifold pressure signal MAP from a manifold pressure sensor may be used to provide an indication of vacuum, or pressure, in the intake manifold. Note that various combinations of the above sensors may be used, such as a MAF sensor without a MAP sensor, or vice versa. During stoichiometric operation, the MAP sensor can give an indication of engine torque. Further, this sensor, along with the detected engine speed, can provide an estimate of charge (including air) inducted into the cylinder. In one example, sensor 120, which is also used as an engine speed sensor, may produce a predetermined number of equally spaced pulses every revolution of the crankshaft.

As described above, FIG. 1 shows only one cylinder of a multi-cylinder engine. As such, each cylinder may similarly include its own set of intake/exhaust valves, fuel injector(s), spark plug, etc.

As elaborated herein with reference to FIG. 2, an engine controller may inject one or more of a first, liquid fuel, such as gasoline or a gasoline-alcohol blend, to the engine cylinder via direct injector 166, and a second, gaseous fuel, such as CNG, to the engine cylinder via port injector 170, to meet engine torque demands. A variable ratio of fuel injection between the two fuels may be adjusted based on engine operating conditions. For example, at high engine speed-load conditions, more liquid fuel may be used. Increased gasoline usage at those conditions may provide a higher peak torque. However, at low engine speeds and high engine load conditions, when coolant and air charge temperatures are elevated, the engine may become knock-limited with gasoline usage. To address the knock, increased spark retard may be required which results in torque and power loss, as well lowered fuel economy. The lower torque associated with spark retard means that the transmission needs to be downshifted to provide driver-demanded torque. However, this leads to a drop in fuel economy. The inventors herein have recognized that during the same conditions, a shift to CNG-only usage provides various advantages. For example, the octane of CNG enables MBT spark that results in a peak torque output that is substantially higher than the peak torque output by gasoline usage under the same conditions. In addition, the extra torque output can be leveraged to enable an early transmission upshift or delayed transmission downshift. In doing so, vehicle responsiveness and fuel economy is improved.

FIG. 3 shows a map 300 depicting the torque benefit provided by CNG at low engine speeds. Map 300 shows engine torque along the y-axis and engine speed along the x-axis for different fuels. In particular, torque output for a gasoline fuel having an octane of 87 is shown at plot 302 (dashed line), torque output for the same gasoline fuel under hot conditions (that is, when engine coolant temperature and air charge temperature are elevated) is shown at plot 304 (solid line), and torque output for a CNG fuel is shown at plot 306 (dotted line). As can be seen by comparing plots 302 to 306, the torque output of the gasoline fuel falls at lower engine speeds, falling further as air charge temperature rises. During those same conditions, CNG provides a substantial torque advantage, with the torque output from CNG being as much as 120% the torque output available with the gasoline fuel.

FIG. 4 compares the torque benefits achieved at different engine speed-load regions through the use of a co-fueling approach, wherein the cylinder is fueled with each of gasoline and CNG for a given combustion event (depicted at table 400), relative to a conventional gasoline only fueling approach (depicted at table 410) as well as a CNG only fueling approach (depicted at table 420).

Each table lists details about engine speed-load regions in the first column. The next two columns depict a fueling approach including a fuel split between gasoline and CNG. The fourth column depicts an equivalence ratio (equivalence ratio is equal to the reciprocal of what is colloquially known in the field as lambda). The fifth column depicts a torque ratio, which is an indication of spark timing (1.0 being timing for best torque if the engine were not knock limited). The last column depicts a torque achieved relative to gasoline only. As such, this is an indication of a torque benefit or torque penalty achieved through the use of the corresponding fueling approach.

As can be seen by comparing tables 400 and 410, during conditions of low engine speed (in the range of 1000-1500 rpm) and high load, while an engine coolant temperature is elevated (e.g., hotter than a threshold temperature) and also while an air charge temperature is elevated (e.g., hotter than a threshold temperature), the conventional gasoline only fueling approach is knock limited (see torque ratio of 0.8 at table 410 which indicates that spark is retarded to provide 80% of available torque). In comparison, the use of CNG alone, or when co-fueled, is not knock limited (see torque ratio of 1.0 at tables 400 and 410 which indicates that spark is substantially at MBT).

During conditions of medium engine speed (in the range of 1500-3000 rpm) and high load, the co-fueling approach is not substantially different from the conventional CNG only fueling in spark control or torque production.

During conditions of a torque band (where engine speed is in the range of 3000-4500 rpm) and high load, as can be seen by comparing tables 400, 410, and 420, the co-fueling approach provides substantial torque benefits. Specifically, the conventional CNG only fueling approach has a relatively large torque penalty (see torque output of 75% relative to gasoline at table 420) while the conventional gasoline only fueling approach achieves the same exhaust cooling at the expense rich operation and spark retard (see torque ratio of 0.8 at table 410). The co-fueling approach uses a small amount of gasoline to meet the torque deficit while also allowing spark to be maintained at MBT. In addition, the co-fueling approach provides a 110% torque output relative to gasoline only, allowing combustion chamber temperature control to be achieved without affecting engine torque output.

During conditions of a power band (where engine speed is in the range of 4500-6000 rpm) and high load, as can be seen by comparing tables 400, 410, and 420, the conventional CNG only fueling approach provides minimal combustion chamber cooling at the expense of running at a rich limit of CNG (10% rich as indicated by equivalence ratio of 1.10 at table 420) while incurring a torque penalty (see torque output of 90% relative to gasoline at table 420). The conventional gasoline only fueling approach achieves the same exhaust cooling at the expense of running 30% rich (see equivalence ratio of 1.30 at table 410) and at the expense of spark retard (see torque ratio of 0.8 at table 410). The co-fueling approach uses a small amount of gasoline at a smaller amount of richness, in addition to the CNG, to operate at MBT and thus restore full power. That is, no torque penalty is incurred with the small gasoline consumption.

During conditions of a power band (where engine speed is in the range of 4500-6000 rpm) and high load, and when the catalyst needs to be protected, as can be seen by comparing tables 400, 410, and 420, the co-fueling approach again provides substantial torque benefits. Specifically, the conventional CNG only fueling approach provides exhaust cooling at the expense of running at a lean limit of CNG (30% lean as indicated by equivalence ratio of 0.70 at table 420) while incurring a torque penalty (see torque output of 70% relative to gasoline at table 420). The conventional gasoline only fueling approach achieves the same exhaust cooling at the expense of running 30% rich (see equivalence ratio of 1.30 at table 410) and at the expense of spark retard (see torque ratio of 0.8 at table 410). The co-fueling approach uses a small amount of gasoline at a smaller amount of richness, in addition to the CNG, to restore full power, while maintaining spark at MBT. That is, no torque penalty is incurred with the small gasoline consumption.

The inventors herein have recognized that the extra torque output through the CNG-only fueling approach can be leveraged at the low engine speed-high engine load-high aircharge temperature conditions to advance a transmission upshift schedule and/or delay a transmission downshift schedule, relative to the transmission shift schedules with gasoline usage only. In doing so, the vehicle responsiveness can be improved. Specifically, an engine operating on CNG may be made “torque-ier” and the “torkyness” of the engine may be made comparable to gasoline usage. The shift schedule which is designed to reduce engine speed also results in a fuel economy. As such, using CNG over gasoline in co-fueling conserves gasoline, which is the higher-priced of the fuels.

An example adjustment of a transmission shift schedule is shown at map 500 of FIG. 5. Specifically, map 500 depicts a first transmission shift schedule for transitioning between gears 1-5 (dotted lines) of the transmission while operating with a first, liquid fuel (such as gasoline) at plot 502 (solid line) and a second transmission shift schedule for transitioning between gears 1-5 (dotted lines) of the transmission while operating with a second, gaseous fuel (such as CNG) at plot 504 (dashed line).

As can be seen by comparing plots 502 and 504, when operating with gasoline, a transmission shift from the transmission first gear (1) to the second gear (2) may be effected after a vehicle speed of 20 mph while the same transmission shift may be effected just before 20 mph when operating the engine with CNG. As such, at higher transmission gears, the upshift can be effected progressively earlier. In other words, a difference between a time (or vehicle speed) at which a transmission fourth gear is shifted to a transmission fifth gear when operating with gasoline relative to when operating with CNG may be larger than the difference in time (or vehicle speed) at which a transmission first gear is shifted to a transmission second gear when operating with gasoline relative to when operating with CNG. Likewise, at higher transmission gears, a downshift can be effected progressively later when operating with CNG, as compared to when operating with gasoline. In addition, given equal vehicle acceleration, plot 504 has lower engine speed than plot 502 and thus it is more pleasing to the vehicle operator. In particular, the vehicle operator would rate that engine as having more torque than the other. Further, the lower engine speed results in better fuel economy due to the reduced friction power expended at the lower engine speeds.

In this way, the system of FIG. 1 enables a method of operating an engine wherein a transmission shift schedule is adjusted based on fuel usage, with a transmission upshift advanced and a transmission downshift delayed in response to shifting engine operation from operating with at least some liquid fuel to operating with only gaseous fuel.

Now turning to FIG. 2, an example routine 200 is shown for adjusting a fuel injection profile and a transmission shift schedule in a multi-fuel engine system (such as the engine system of FIG. 1) so as to improve engine performance. The method enables the selective adjusting of a transmission shift schedule in response to shifting engine operation from operating with a first, liquid fuel to operating with only a second, gaseous fuel. By adjusting the transmission schedule during selected conditions when gaseous fuel provides a higher torque output than liquid fuel, vehicle responsiveness and fuel economy is improved.

At 202, the routine includes estimating and/or measuring engine operating conditions. These may include, for example, engine speed, engine temperature, exhaust catalyst temperature, boost level, MAP, MAF, etc. At 204, the nature and availability of fuels in the fuel tanks of the multi-fuel engine system may be determined. For example, output of fuel tank fuel level sensors may be used to estimate the availability of fuel in each fuel tank. As another example, it may be determined whether the gaseous fuel available is CNG, LPG, hydrogen, etc. As yet another example, the alcohol content of the liquid fuel may be estimated so as to determine the composition of the liquid fuel available (e.g., whether the liquid fuel is E10, E50, E85, M85, etc.).

At 206, based on the estimated engine operating conditions and the determined availability of fuels in the engine's fuel systems, a fuel injection profile may be determined. Specifically, the fuel injection profile may include an amount of a first, liquid fuel (such as gasoline) and/or an amount of a second, gaseous fuel (such as CNG) that is injected into an engine cylinder so as to operate the cylinder at stoichiometry (or an alternate desired air-fuel ratio). The selection of which fuel to use may be based on factors such as availability of the fuel (e.g., fuel level in the fuel tank), torque output provided by the fuel at the given operating conditions, charge cooling effects of the fuel, etc. In one example, the engine may be operated with injection of only the first, liquid fuel. Herein, the first liquid fuel may be delivered to the cylinder as a direct injection with airflow adjusted based on the fuel injection to meet the operator torque demand while providing a desired combustion air-fuel ratio in the engine cylinder (e.g., at stoichiometry, richer than stoichiometry or leaner than stoichiometry). In still another example, the engine cylinder may be co-fueled with at least some of the first liquid fuel direct injected and at least some of the second gaseous fuel port injected into the cylinder. At least some liquid fuel may be used during conditions when the peak torque output by the first liquid fuel is higher than the second gaseous fuel. In another example, the engine may be operated with port injection of only the second, gaseous fuel. The relative amounts of the first and second fuel injected into the engine may also be adjusted based on, for example, engine speed-load conditions. For example, as discussed with reference to the tables of FIG. 4, at mid speed-load conditions, a gasoline-only fueling approach may be applied while at high speed-load conditions, when exhaust catalyst protection is required, a co-fueling approach may be applied. Therein, each of gasoline and CNG may be injected into

In the depicted example, the first liquid fuel is gasoline and the second gaseous fuel is CNG. However, it will be appreciated that other fuel combinations may be possible. For example, the liquid fuel may alternatively be a gasoline ethanol blend such as E10 or E85.

At 208, it may be determined if under the given operating conditions, the peak torque output by the engine while operating with gasoline (TQgas) is higher than the peak torque output by the engine while operating with CNG (TQcng). If yes, then at 210, the routine includes using a fuel injection profile that uses at least some gasoline. For example, only an amount of the liquid gasoline fuel may be injected into the cylinder. Alternatively, a first amount of liquid gasoline fuel and a second amount of gaseous CNG fuel may be injected into the cylinder. As such, during conditions when peak torque generated with injection of the second fuel is lower than peak torque generated with injection of the first fuel, the engine is not operated with only the second fuel.

At 212, during conditions where the engine is operated with only the first fuel or each of the first fuel and the second fuel, the routine includes maintaining a transmission shift schedule. For example, the engine may be operated with a first transmission shift schedule (e.g., a scheduled based on gasoline usage) when operating with at least some liquid fuel.

If the peak torque output by the engine while operating with gasoline is not higher than the peak torque output by the engine while operating with CNG, then at 214, it may be confirmed that the peak torque output by the engine while operating with CNG is higher than the peak torque output by the engine while operating with gasoline. If yes, at 216, during the selected condition when peak torque generated with injection of the second fuel is higher than peak torque generated with injection of the first fuel, the routine includes selectively injecting only the gaseous fuel into the engine cylinder. The selected condition may include engine speed being lower than a threshold speed (e.g., engine speed in the range of 1000-1500 rpm), engine load being higher than a threshold load (e.g., engine load where MAP is at or around BP), and aircharge temperature being above a threshold temperature. During such conditions, by shifting to use of only a gaseous fuel, a torque advantage is achieved. In one example, by using only CNG during these conditions, 120% more peak torque may be output than when using gasoline alone. Furthermore, since gasoline operation during these conditions can lead to an increased propensity for abnormal combustion events such as knocking and misfire, as well as engine materials damage, by shifting to use of the gaseous CNG fuel, the octane of CNG is used to improve the engine's knock limit.

At 218, in addition to adjusting the injection profile, the routine includes selectively changing the transmission shift schedule based on a change in fuel injection from injection of the first fuel to injection of second fuel. For example, the transmission schedule may be shifted from a first transmission shift schedule based on gasoline usage to a second, different transmission shift schedule based on CNG usage. As such, adjusting the transmission shift schedule includes adjusting each of a transmission upshift schedule and a transmission downshift schedule. The adjusting may include, as elaborated with reference to FIG. 5, advancing the upshift schedule and delaying the downshift schedule when operating with only the second, gaseous fuel, the advancing and delaying relative to the (first) transmission shift schedule based on engine operation with only the first liquid fuel. A degree of advancing the upshift schedule and a degree of retarding the downshift schedule may be based on barometric pressure while operating the engine with only the second fuel. For example, the upshift schedule may be advanced further as BP increases and the downshift schedule may be delayed further as BP increases. This is because, on a non-boosted engine, maximum torque at a given engine speed is influenced by the atmospheric pressure (or density). As such, since air density is related to barometric pressure, in one example, a degree of advancing the upshift schedule and a degree of retarding the downshift schedule may be based on ambient air density. Therein, while operating the engine with only the second fuel, the upshift schedule may be advanced further as the air density increases and the downshift schedule may be delayed further as the air density increases.

In still other examples, the schedule may be adjusted based on how much higher the peak torque output is when injecting the second gaseous fuel as compared to the peak torque output when injecting the first liquid fuel. Further still, the controller may use a map, such as the map of FIG. 5 to adjust the shift schedule based on fuel usage and operating conditions (e.g., vehicle speed) and further based on the nature of the gear shift. For example, the schedule may be adjusted differently when the transmission is upshifted from a transmission first gear to a transmission second gear relative to when it is upshifted from a second gear to a third gear. Likewise, the schedule may be adjusted differently when the transmission is downshifted from a transmission second gear to a transmission first gear relative to when it is downshifted from a third gear to a second gear.

While the routine of FIG. 2 depicts adjusting an injection profile and a transmission shift schedule based on the peak torque output of the liquid fuel relative to the gaseous fuel at the given operating conditions, it will be appreciated that in alternate embodiments, the decision may be based on whether the engine is operating with only the liquid fuel being injected, only the gaseous fuel being injected, or both the fuels being co-fueled into the same cylinder for the same combustion event. For example, in alternate embodiment of FIG. 2, at 208 it may be determined if the engine is operating with at least some liquid fuel, such as with only gasoline being injected or at least some gasoline being injected. If yes, then the first transmission shift schedule may be applied (or maintained) at 212. As such, at least some gasoline may be used during conditions when the peak torque output of gasoline is higher than the peak torque output of CNG. In comparison, if the engine is operating with only gaseous fuel (such as with only CNG) at 214, then the second transmission shift schedule may be applied, or transitioned to, at 218. As such, only CNG may be used during conditions when the peak torque output of CNG is higher than the peak torque output of gasoline.

In one example, during a first condition, while operating the engine with only a liquid fuel to provide higher peak torque, a transmission may be upshifted at a first speed and downshifted at a second speed. In comparison, during a second condition, while operating the engine with only a gaseous fuel to provide higher peak torque, the transmission may be upshifted at a third speed, earlier than the first speed and downshifted at a fourth speed, later than the second speed. The first condition may include engine speed being higher than a threshold speed, engine load being higher than a threshold load, and aircharge temperature (or exhaust temperature) being lower than a threshold temperature, while the second condition may include engine speed being lower than the threshold speed, engine load being higher than the threshold load, and aircharge temperature (or exhaust temperature) being higher than the threshold temperature. The liquid fuel may include gasoline or a gasoline-alcohol blend, and the gaseous fuel may include CNG. Herein, during the first condition, the peak torque generated with injection of the first fuel may be higher than peak torque generated with injection of the second fuel, while during the second condition, the peak torque generated with injection of the second fuel may be higher than peak torque generated with injection of the first fuel.

While the routine of FIG. 2 depicts changing between fuel injection profiles in response to selected conditions being met, it will be appreciated that in the event that one of the fuels runs out, the system may automatically shift to operating the engine with whichever fuel is available. In addition, the transmission shift schedule (for that fuel usage) may be maintained. Likewise, in case of degradation of any one of the fuel systems, the controller may automatically shift to operating the engine with whichever fuel system is functional, while maintaining the transmission shift schedule for the fuel being used. For example, while a shift to CNG-only operation provides a torque benefit during the selected conditions (at 216), if there is not a sufficient amount of CNG (as required for CNG-only operation), or if a component of the CNG fuel system is degraded, then at 216, the routine may continue to operate the engine with at least some gasoline, and maintain the first transmission shift schedule corresponding to gasoline usage.

Turning to FIG. 6, map 600 depicts an example fuel injection adjustment and transmission schedule adjustment in a multi-fuel engine system responsive to operating conditions. The adjustments include adjusting fuel injection based on which fuel provides a peak torque output, and adjusting the transmission schedule based on the fuel selection and torque output. The adjustments enable torque benefits to be used for scheduling transmission upshifts. Map 600 depicts fueling of a first, liquid fuel (herein gasoline) to a cylinder at plot 602, fueling of a second, gaseous fuel (herein CNG) to the cylinder at plot 604, exhaust temperature (Texh) at plot 606, transmission gear shifts at plot 608, and changes in engine speed (Ne) at plot 610.

Prior to t1, the engine may be operating with a first amount of the first, liquid fuel, herein gasoline (plot 602), and a second amount of the second gaseous fuel, herein CNG (plot 604), to meet engine torque demands. As such, prior to t1, engine speed may be higher than a threshold speed 612 (plot 610) while engine load (not shown) is also high. In addition, the transmission may be at a first gear (plot 608). The first gear may be a first, lower gear such as a transmission first gear or a transmission second gear. Also, prior to t1, the exhaust temperature may be below a threshold temperature 605 (plot 606).

Shortly before t1, due to a change in operating conditions, engine speed may decrease such that at t1, the engine speed is at or below threshold speed 612. As such, the engine speed may be in a low speed range while engine load (not shown) remains high. Also before t1, the exhaust temperature may start to rise. While the exhaust temperature remains below threshold temperature 605 at t1, between t1 and t2, the temperature may rise and at t2, while engine speed remains below threshold speed 612 and while engine load remains high, exhaust temperature may rise above threshold temperature 605.

As such, at the selected conditions existing at t2 (low engine speed, high engine load, elevated exhaust temperature), engine operation with gasoline injection may become knock limited. In addition, at the selected conditions, CNG injection may provide a higher peak torque output relative to gasoline usage. Thus, at t2, a fuel injection profile may be adjusted to reduce the gasoline usage (to no gasoline usage) and increase the CNG usage (to only CNG usage) to meet torque demand. In addition, the higher torque output achieved with the CNG injection is leveraged to upshift the transmission from the first, lower gear to a second, higher gear at t2 itself. Herein, the second gear is a transmission gear that is higher than the first gear, such as a transmission second gear, third gear, etc.

In response to the transmission upshift, engine speed may increase shortly after t2. Between t2 and t3, due to a change in operating conditions, engine speed may continue to rise until at t3, engine speed is at or above threshold speed 612. In addition, between t2 and t3, exhaust temperatures may gradually decrease until at t3, exhaust temperature is at or below threshold temperature 605. At t3, when engine speed is higher (while engine load remains high), and while exhaust temperatures are lower, the torque advantage provided by CNG usage may cease to exist. Rather, further CNG usage may lead to a reduced peak torque output. Thus, at t3, injection of gasoline may be increased while injection of CNG is decreased. In one example, the engine may shift to only gasoline usage. Alternatively, the engine may shift to a co-fueling approach where both gasoline and CNG are injected into the same cylinder for combustion during the same combustion event.

Herein, the higher torque output of the CNG only fuel injection is advantageously used to provide an earlier transmission upshift (at t2) than would otherwise have been possible with gasoline usage. For example, if gasoline were used, a transmission upshift would have been enabled between t2 and t3, as shown by segment 609 (dashed line). By advancing the transmission upshift, various advantages are achieved. First, fuel economy is improved. Second, the octane of CNG improves the engine's knock limit. Finally, the engine's responsiveness is improved. In particular, the engine is revved up, rendering the engine more “torque-ier” when operating with CNG, and comparable to the responsiveness achieved with gasoline usage.

While not depicted, it will be appreciated that when operating with only CNG, the higher torque output can be similarly leveraged to provide a later downshift than would be possible with gasoline usage.

In one example, an engine system comprises an engine including a cylinder, a first direct injector configured to direct inject a first, liquid fuel into the cylinder, a second port injector configured to port inject a second, gaseous fuel into the cylinder, and a transmission including one or more transmission gears. An engine controller may be configured with computer readable instructions for, during conditions when injection of the second fuel provides higher peak torque than injection of the first fuel, selectively injecting only the second fuel and adjusting a transmission shift schedule. In addition, during conditions when injection of the first fuel provides higher peak torque than injection of the second fuel, the controller may inject an amount of the first fuel and maintaining the transmission shift schedule. Herein, injecting an amount of the first fuel includes injecting only the amount of the first fuel (that is, single fueling) or injecting a first amount of the first fuel and a second amount of the second fuel (that is, co-fueling). The adjusted transmission shift schedule may include an earlier upshift schedule and a later downshift schedule as compared to the maintained transmission schedule.

In this way, the attributes of each of a gaseous fuel and a liquid fuel in a multi-fuel engine system may be leveraged. By shifting towards increased liquid fuel usage at higher engine speed-load conditions, the higher torque output of the liquid fuel can be used to meet peak power demand. By shifting towards increased gaseous fuel usage at low speed-high conditions, the higher torque output and cylinder cooling effect of the gaseous fuel can be used to provide a torque advantage. Furthermore, the torque advantage can be advantageously used to advance a transmission upshift and/or delay a transmission downshift, thereby improving the responsiveness of the vehicle. By adjusting the transmission shift schedule responsive to fuel usage, the performance of an engine operating with a gaseous fuel, such as CNG, can be made as high as the performance of the engine when operating with a liquid fuel, such as gasoline. By making the engine more torque-responsive when operating with CNG, a drive feel can be improved.

Note that the example control and estimation routines included herein can be used with various system configurations. The specific routines described herein may represent one or more of any number of processing strategies such as event-driven, interrupt-driven, multi-tasking, multi-threading, and the like. As such, various actions, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, functions, or operations may be repeatedly performed depending on the particular strategy being used. Further, the described operations, functions, and/or acts may graphically represent code to be programmed into computer readable storage medium in the control system.

Further still, it should be understood that the systems and methods described herein are exemplary in nature, and that these specific embodiments or examples are not to be considered in a limiting sense, because numerous variations are contemplated. Accordingly, the present disclosure includes all novel and non-obvious combinations of the various systems and methods disclosed herein, as well as any and all equivalents thereof.

1. A method for an engine, comprising:
selectively adjusting a transmission shift schedule in response to shifting engine operation from operating with a first, liquid fuel to operating with only a second, gaseous fuel.

2. The method of claim 1, wherein the first liquid fuel is gasoline or a gasoline-alcohol fuel blend, and wherein the second gaseous fuel is CNG, and wherein the selectively adjusting includes changing the transmission shift schedule based on a change in fuel injection from injection of the first fuel to injection of second fuel.

3. The method of claim 2, wherein the selectively adjusting includes adjusting the transmission shift schedule during a selected condition when peak torque generated with injection of the second fuel is higher than peak torque generated with injection of the first fuel.

4. The method of claim 3, wherein the selected condition includes engine speed being lower than a threshold speed, engine load being higher than a threshold load, and air charge temperature being above a threshold temperature.

5. The method of claim 3, further comprising, during other conditions, operating the engine with each of the first fuel and the second fuel and maintaining the transmission shift schedule.

6. The method of claim 3, further comprising, during conditions when peak torque generated with injection of second fuel is lower than peak torque generated with injection of first fuel, not operating the engine with only the second fuel and maintaining the transmission shift schedule.

7. The method of claim 3, wherein the adjusting includes shifting from a first transmission shift schedule based on gasoline usage to a second, different transmission shift schedule based on CNG usage.

8. The method of claim 1, wherein adjusting a transmission shift schedule includes adjusting each of a transmission upshift schedule and a transmission downshift schedule.

9. The method of claim 7, wherein the adjusting includes advancing the upshift schedule and delaying the downshift schedule when operating with only the second, gaseous fuel, the advancing and delaying relative to a transmission shift schedule based on engine operation with only the first liquid fuel.

10. The method of claim 8, wherein a degree of advancing the upshift schedule and a degree of retarding the downshift schedule is based on ambient air density, and wherein while operating the engine with only the second fuel, the upshift schedule is advanced further as the air density increases and the downshift schedule is delayed further as the air density increases.

11. A method for an engine, comprising:
during a first condition, while operating the engine with only a liquid fuel to provide higher peak torque, upshifting a transmission at a first speed and downshifting the transmission at a second speed; and
during a second condition, while operating the engine with only a gaseous fuel to provide higher peak torque, upshifting the transmission at a third speed, earlier than the first speed and downshifting the transmission at a fourth speed, later than the second speed.

12. The method of claim 11, wherein the first condition includes engine speed being higher than a threshold speed, engine load being higher than a threshold load, and air charge temperature being lower than a threshold temperature, and wherein the second condition includes engine speed being lower than the threshold speed, engine load being higher than the threshold load, and air charge temperature being higher than the threshold temperature.

13. The method of claim 11, wherein the liquid fuel includes gasoline or a gasoline blend, and wherein the gaseous fuel includes CNG, and wherein during the first condition, peak torque generated with injection of the first fuel is higher than peak torque generated with injection of the second fuel, and wherein during the second condition, peak torque generated with injection of the second fuel is higher than peak torque generated with injection of the first fuel.

14. The method of claim 11, wherein operating with only liquid fuel includes direct injecting the liquid fuel and wherein operating with only the gaseous fuel includes port injecting the gaseous fuel.

15. An engine system, comprising:
an engine including a cylinder;
a first direct injector configured to direct inject a first, liquid fuel into the cylinder;
a second port injector configured to port inject a second, gaseous fuel into the cylinder;
a transmission including one or more transmission gears; and
a controller with computer readable instructions for:
during conditions when injection of the second fuel provides higher peak torque than injection of the first fuel, selectively injecting only the second fuel and adjusting a transmission shift schedule.

16. The system of claim 15, further comprising, during conditions when injection of the first fuel provides higher peak torque than injection of the second fuel, injecting an amount of the first fuel and maintaining the transmission shift schedule.

17. The system of claim 16, wherein injecting an amount of the first fuel includes injecting only the amount of the first fuel or injecting a first amount of the first fuel and a second amount of the second fuel.

18. The system of claim 16, wherein the adjusted transmission shift schedule includes an earlier upshift schedule and a later downshift schedule as compared to the maintained transmission schedule.

19. The system of claim 15, wherein the conditions when injection of the second fuel provides higher peak torque than injection of the first fuel include, when engine speed is lower than a threshold speed and engine load is higher than a threshold load, and air charge temperature being higher than a threshold temperature.

20. The system of claim 16, wherein the first liquid fuel includes gasoline or a gasoline-alcohol blend, and wherein the second gaseous fuel includes CNG.
